(19) United States
(12) Patent Application Publication
(10) Pub. No.: US 2010/0196109 A1
(43) Pub. Date: Aug. 5, 2010

(54) CUTTING TOOLS HAVING PLASMA DEPOSITED CARBON COATINGS

(75) Inventors: Xu Shi, Singapore (SG); Xiao Zhe Jin, Singapore (SG); Li Kang Cheah, Singapore (SG)

Correspondence Address: WOODCOCK WASHBURN LLP, CIRA CENTRE, 12TH FLOOR, 2929 ARCH STREET, PHILADELPHIA, PA, 19104-2891, US

(73) Assignee: NANOFILM TECHNOLOGIES INTERNATIONAL PTE LTD, Singapore (SG)

(21) Appl. No.: 12/666,537

(22) PCT Filed: Jun. 26, 2007
(86) PCT No.: PCT/SG2007/000179

§ 371 Date: Mar. 15, 2010

(51) Int. Cl. B23B 27/14

(52) U.S. Cl. 408/144; 407/119

(57) ABSTRACT

A cutting tool comprising a body, a cutting edge on at least one part of said body and a plasma deposited carbon coating layer provided on said cutting edge that is substantially free of macro-particles.

### TECHNICAL FIELD

The present invention generally relates to coated cutting tools such as tool bits, such as, for example, carbon coated tool bits used in the manufacture of printed circuit boards (here called “PCB”).

### BACKGROUND

Machining operations on PCB'S must be precise and match very close tolerances. For boring operations using a drill bit or other similar rotary boring device, the tolerances are measured in respect of bore diameter, axial straightness, and depth of bore.

The substrates of PCB's are usually made from materials that are difficult to drill (ie fiberglass) and which impart high demands on drill bits and other rotary boring tools that are used during PCB manufacture. Materials such as fiberglass can be very abrasive and tend to dull the drill bit ends relatively quickly. This results in the drill bits failing to meet tolerance standards, which results in dimensional faults arising in the manufacture of the PCB board.

To overcome the problems associated with high wear rates of the drill bits, it is known to coat the drill bits with a hard coating, such as hardened carbide steel, to prevent the rates at which the drill bits are dulled. However, due to the abrasiveness of the PCB board material, most hardened carbide PCB drill bits have a life of between about 500 and 2,000 cycles out of each drill bit before it is so dull that it is spent and must be replaced.

Tools bits having carbon coatings deposited by physical vapor deposition are disclosed in U.S. Pat. No. 6,881,475 (Ohtani et al). Ohtani teaches a carbon coated tool consisting of a base material of tungsten carbide, an amorphous carbon film of thickness 0.05 μm to 0.5 μm deposited onto a cutting edge of the tungsten carbide base and an interlayer of thickness 0.5 nm to 10 nm disposed between the base layer and carbon coating layer. A problem with physical vapor deposition depositing methods is that relatively hard “macro-particles” are deposited on the surface undergoing coating, which are undesirable because they increase the cutting resistance of the tool. Ohtani recognized that it is desirable to have as small macro-particle density as possible. However, while Ohtani did recognize the need to obtain as low macro-particle density as possible on the carbon coating, its typical macro-particle density was still in the order of 70,000 to 260,000. While Ohtani does disclose one sample having a macro-particle density of 24,000 it would be more desirable to have an even lower particle density. Furthermore, the coating thickness of the low macro-particle density sample was also low (50 nm) and there was no inter-layer disposed between the carbon coating outer-layer and the tungsten carbide base material.

There is a need to provide tool bits that overcome, or at least ameliorate, one or more of the disadvantages described above.

### SUMMARY

According to a first aspect, there is provided a cutting tool comprising:

a body;

a cutting edge on at least one part of said body; and

a plasma deposited carbon coating layer provided on said cutting edge that is substantially free of macro-particles.

Advantageously, as the carbon coating layer is substantially free of macro-particles, it has reduced cutting resistance relative to cutting tools coated with carbon having macro-particles disposed within the coating. More advantageously, the cutting tool may be a tool bit which when used to bore holes in PCB material, the plasma deposited carbon coating layer being substantially free of macro-particles, significantly extends the cycle life of the tool bit relative to known hard coating layers.

In one embodiment, the cutting tool is a tool bit comprising:

a cylindrical body having a longitudinal axis;

a tool engagement end on one end of said body for engagement with a tool capable of rotating, said cylindrical body about said longitudinal axis;

a working end on an opposite end of said body to said tool engagement end; and

a plasma deposited carbon coating layer provided on said working end that is substantially free of macro-particles. In use, said coated working end bores a hole into a work piece as said cylindrical body is rotated about its longitudinal axis.

The carbon coating layer may have thickness that is at least more than 10 nm. The carbon coating layer may have a thickness selected from the group consisting of 20 nm to 5000 nm, 20 nm to 4000 nm, 250 nm to 3000 nm, 250 nm to 2500 nm, 250 nm to 2000 nm, 250 nm to 1500 nm, 250 nm to 1000 nm, 500 nm to 3000 nm, 500 nm to 2500 nm, and 1000 nm to 2000 nm.

The carbon coating layer may have a hardness of at least 5 GPa, preferably at least 10 GPa. Optionally, the hard coating layer has a hardness of 5 GPa to 60 GPa or 10 GPa to 60 GPa or 20 GPa to 45 GPa.

In one embodiment, the carbon coating layer comprises a primary layer provided on said cutting edge and a secondary layer provided on said primary layer, wherein the hardness of said secondary layer is higher than said primary layer. Optionally, the primary layer has a hardness of 5 GPa to 20 GPa or 5 GPa to 10 GPa and said secondary layer has a hardness of 10 GPa to 60 GPa or 20 GPa to 45 GPa. In one embodiment, the primary and secondary layers have respective thickness within the range of 10 nm to 2500 nm, 10 nm to 1500 nm, 250 nm to 1500 nm, 500 nm to 1500 nm, and 800 nm to 1500 nm.

A metal carbide inter-layer or metal inter-layer may be disposed between the cutting edge and the carbon coating layer. The metal of the metal carbide inter-layer or metal inter-layer may be a transition metal. The transition metal may be selected from the group consisting of Ti, Zr, Hf, V, Nb, Ta, Cr, Mo, W, Fe, Ru, Os, and combinations thereof.

In one embodiment, the transition metal carbide is titanium carbide, chromium carbide or mixtures thereof. In another embodiment, the metal of the metal inter-layer is titanium, chromium or alloys thereof.

The carbon coating layer may have been deposited using a plasma sourced from a filtered cathodic vacuum arc.

In one embodiment, the cutting tool is a printed circuit board (PCB) drill bit. In another embodiment, the cutting tool is a printed circuit board (PCB) router bit.

The cylindrical body may have a diameter selected from the group consisting of 0.001 mm to 3 mm; 0.05 mm to 3 mm; 0.05 mm to 3 mm; 0.05 mm to 2 mm; 0.05 mm to 1 mm; 0.05 mm to 0.5 mm and 0.05 mm to 0.25 mm.

In one embodiment, the cutting tool comprises a metal layer disposed between said working end and said hard coating layer. The thickness of the metal layer may be 250 nm to 1500 nm.

In one embodiment, the cylindrical body comprises tungsten carbide and cobalt.

In one embodiment, there is provided a tool bit comprising:

a cylindrical body having a longitudinal axis;

a tool engagement end on one end of said body for engagement with a tool capable of rotating said cylindrical body about said longitudinal axis;

a working end on an opposite end of said body to said tool engagement end;

a plasma deposited primary carbon layer provided on said working end that is substantially free of macro-particles

a plasma deposited secondary carbon coating layer provided on said primary carbon coating layer that is substantially free of macro-particles, wherein the hardness of said secondary carbon coating layer is harder relative to said primary carbon coating layer;

wherein in use, said coated working end bores a hole into a work piece as said cylindrical body is rotated about its longitudinal axis.

The plasma deposited carbon coating layer may exhibit Raman intensity values of between about 0.3 to about 1 or about 0.5 to about 0.8.

According to a second aspect, there is provided a method of coating a tool bit comprising a cylindrical body having a longitudinal axis, a tool engagement end on one end of said body for engagement with a tool capable of rotating said cylindrical body about said longitudinal axis, and a working end on an opposite end of said body to said tool engagement end, the method comprising the step of (a) depositing plasma carbon ions onto said working end to form a carbon layer thereon that is substantially free of macro-particles.

The method may, before step (a), the steps of: (b) generating a plasma beam comprising carbon ions in an inert atmosphere, or under vacuum, from a cathodic vacuum arc source; and

(c) filtering said plasma beam to substantially remove all macroparticles therefrom.

The method may comprise, during step (a), the step of:

(d) applying an alternating bias pulse to said working end of said tool bit, said bias pulse alternating between a relatively high negative bias pulse and a low negative bias pulse.

The method may comprise the step of (d1) selecting said high negative bias pulse from the group consisting of the range −500 V to −5,000 V, −1000 V to −3,000 V, −1800 V to −4,500 V and −2000 V to −2500 V.

The method may comprise the step of (d2) selecting a floating power source or selecting said low negative bias pulse from the group consisting of the range −50 V to −500 V, −100 V to −200 V, and −50 V to −150.

The method may comprise the step of (e) pulsing the bias on the substrate at a frequency of up to 10 kHz or up to 5 kHz. The pulsing step (e) may comprise the step of (e1) selecting the frequency from the range of 1 kHz to 3 kHz.

The pulsing step (e) may comprise the step of (e2) selecting the pulse duration from the group consisting of 1 μs to 50 μs, 1 μs to 25 μs, 30 μs to 50 μs and 5 μs to 10 μs.

The relatively high negative bias and the low negative bias may be alternately undertaken for a duration of time selected from the group consisting of 0.1 seconds to 20 seconds or 1 second to 5 seconds.

According to a third aspect, there is provided use of a tool bit for printed circuit board (PCB) manufacture, the tool bit comprising:

a cylindrical body having a longitudinal axis;

a tool engagement end on one end of said body for engagement with a tool capable of rotating said cylindrical body about said longitudinal axis;

a working end on an opposite end of said body to said tool engagement end; and

a plasma deposited carbon coating layer provided on said working end that is substantially free of macro-particles,

wherein in use said coated working end bores a hole into said PCB as said cylindrical body is rotated about its longitudinal axis.

According to a fourth aspect, there is provided a method of making a tool bit comprising the steps of:

(a) providing a tool bit comprising a cylindrical body having a longitudinal axis, a tool engagement end on one end of said body for engagement with a tool capable of rotating said cylindrical body about said longitudinal axis, and a working end on an opposite end of said body to said tool engagement end; and

(b) depositing plasma carbon ions onto said working end that are substantially free of macro-particles to form a carbon layer thereon that is substantially free of macro-particles.

According to a fifth aspect, there is provided a printed circuit board (PCB) drill bit or router bit comprising:

a cylindrical body having a longitudinal axis;

a tool engagement end on one end of said body for engagement with a tool capable of rotating said cylindrical body about said longitudinal axis;

a working end on an opposite end of said body to said shank end; and

a plasma deposited carbon coating layer on said working end that is substantially free of macro-particles for boring a hold into said PCB as said cylindrical body is rotated about its longitudinal axis.

According to a sixth aspect, there is provided use of a tool bit for boring a hole into a board during the manufacture of a printed circuit board (PCB), the tool comprising:

a cylindrical body having a longitudinal axis;

a tool engagement end on one end of said body for engagement with a tool capable of rotating said cylindrical body about said longitudinal axis;

a working end on an opposite end of said body to said shank end; and

a carbon coating layer on said working end that is substantially free of macro-particles and which has a thickness of about 1.5 μm or less,

wherein in use, said carbon layer bores a hole into said PCB as said cylindrical body is rotated about its longitudinal axis.

According to a seventh aspect, there is provided a printed circuit board (PCB) having one or more holes that have been bored with a tool bit as claimed in the first aspect.

According to an eighth aspect, there is provided a method of boring a hole into the substrate of a printed circuit board (PCB) comprising the step of:

(a) drilling a drill or router tool bit into the PCB board substrate, the end of said tool bit comprising a plasma deposited carbon coating layer thereon that is substantially free of macroparticles.

### DEFINITIONS

The following words and terms used herein shall have the meaning indicated:

The terms “macro-particles”, “macro-particle” and “macroparticles” are large (typically 0.1 microns up to 10 microns), typically neutral, particles that are multi-atom clusters that are visible under the optical microscope in a film deposited using cathodic arc methods.

The term “substantially free of macro-particles” means that the density of macro-particles in a coating film deposited by a plasma of carbon ions is less than at least 10,000 particles/mm², more preferably less than at least 1,000 particles/mm².

The term “tool bit”, in the context of this specification, refers to a tool bit used for axial boring and includes within its scope drill bits, end mills and router bits, for boring holes into work pieces. In one embodiment, the tool bits are used in the electronics industry for PCB fabrication and particularly, where the tool bits are used to axially bore holes into the substrate of PCBs.

The term “working end”, in the context of this specification, refers to the end of the tool bit on which the plasma deposited carbon coating layer is coated with carbon and which does the actual boring into the work piece.

The term “tool engagement end”, in the context of this specification, refers to the end of the tool bit that is engageable with a tool capable of rotating the tool bit about its longitudinal axis. For example, the tool engagement end may comprise a shank portion that is capable of being inserted into, and lockingly engaged by, a chuck of a drill.

The term ‘hard coating layer’, in the context of this specification, refers to a carbon coating layer that has a hardness that is harder relative to the hardness of the working end of the tool bit. Typically, the hardness of the coating layer is at least 10 GPa, more typically the hardness of the coating layer is between 10 GPa to 35 GPa.

The term “cutting edge” is to be interpreted broadly to include any part of a tool body that is capable of cutting a material. It should be noted that the term is not limited to an actual edge of a tool but may refer to a particular point of a tool that is able to perform a cutting operation. For example, in a drill bit cutting tool, the cutting edge may be a “working end” being the end of the drill bit that is capable of being driven into a solid bit and thereby cut it. Hence, the terms “cutting edge” and “working end” could be used inter-changeable when describing a drill bit.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic side view of a coated tool bit in accordance with one disclosed embodiment;

FIG. 2 is a schematic cross-sectional view of one coating embodiment applied to the working end of the tool bit of FIG. 1; and

FIG. 3 is a schematic cross-sectional view of another coating embodiment applied to the working end of the tool bit of FIG. 1.

### DETAILED DESCRIPTION OF EMBODIMENTS

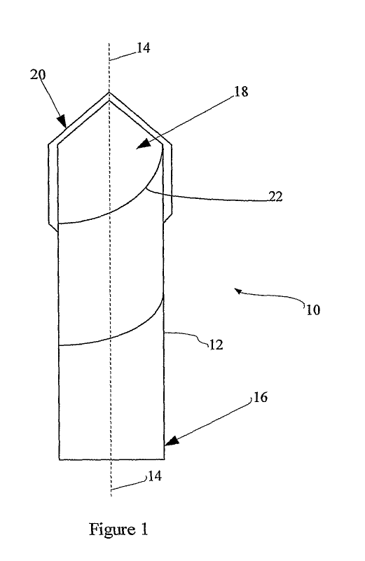

Referring to FIG. 1 there is shown a schematic side view of a cutting tool in the form of drill bit 10. Although the following description will describe the drill bit 10, it should be realized that this is for convenience only and that the following description could equally apply to other cutting tools such as masonry drills, end mills, router bits, knives, lathes, chain saws, saws, scissors etc.

The drill bit 10 includes a cylindrical body 12 having a longitudinal axis extending therethrough as represented by dashed line 14. The body 12 is made from a tungsten carbide and cobalt alloy (WC—Co). WC—Co tool bits are known in the art and are commercially available from a number of manufacturers such as SFS Carbide Tool, Inc. of Saginaw, Mich., United States of America and SGS Carbide Tool (UK) Ltd, Wokingham, Berkshire, United Kingdom.

The body 12 includes a tool engagement end in the form of shank end 16 and a working end in the form of end 18, which is on an opposite end of the body 12 to the shank end 16. The body also includes spiral formations extending from the end 18 to the middle of the body 12. The spiral formations assist in boring a hole into a PCB board as will be explained further below.

The shank end 16 has a dimension and a shape configuration that allows it to be engaged by a chuck (not shown) of a drilling tool so that the body 12 can be rotated about the longitudinal axis 14 in use.

The working end 18 is coated with a carbon coating layer 20, which is hard relative to the body 12. The carbon coating layer 20 comprises carbon which has been deposited onto the working end 18 by a plasma beam consisting of carbon ions. As will be described further below, the plasma beam of carbon ions has been filtered and so it substantially free of macro-particles. Hence, the carbon coating layer 20 is substantially free of macro-particles.

The plasma beam is generated from a graphite target using a Filtered Cathodic Vacuum Arc (FCVA) apparatus developed by Nanofilm Technologies International Pte Ltd (NTI) of Singapore and described in published International patent application WO 96/26531 and U.S. Pat. No. 7,014,738, which are both incorporated herein in their entirety for reference. The FCVA apparatus generates a plasma beam from a cathodic arc source that is “filtered” in that it is substantially free of macroparticles comprising particles of neutral multi-atom clusters.

A bias is applied to the end 18 using a power supply. Any number of power supplies can be used such as a “high voltage pulse generator” (HVPG) available from NTI. The power unit has a control panel on which the parameters can be manually set. Also employed is a switching device insulated gate bipolar transistor (IGBT) which is protected against current overloads and short circuits. The generator assembly is also equipped with an output fuse.

The output range of the pulse generator is up to −10,000 V, preferably −5,000 V, and more preferably −2,000 V to −4,000 V, with the pulses lasting from between 1-50 μs; for direct arc sources preferably from between 1-20 μs, more preferably from between 5-10 μs, and for FCVA sources preferably from between 10-40 μs, more preferably 15-25 μs; and at a frequency of up to 10 kHz, preferably from 1-3 kHz, more preferably from 1.5-2.5 kHz.

The HVPG is associated with the FCVA apparatus, and connected to the drill, bit 10. During operation of the FCVA apparatus, the HVPG is set to deliver pulses of large negative voltage to the drill bit 10. The HVPG is started and stopped either manually or via remote

The thickness of the carbon coating layer 20 is between about 0.1-1 μm. Hence, the carbon coating layer 20 is very thin and cannot be seen by the naked eye, but its thickness, as shown in FIG. 1, is exaggerated for the purposes of illustration.

It has surprisingly been found by the inventors that the carbon coating layer 20 deposited by the FCVA apparatus provides a longer cycle life than known carbon coatings deposited by other deposition methods. Without being bound by theory, it is thought that the plasma deposited carbon ions ensures very tight adherence of the carbon coating layer to the end 18, thereby increasing the cycle life of the drill bit 10. Furthermore, because layer upon layer of carbon ions are deposited on each other to form the carbon coating, it is thought that an extremely tight coating layer builds up providing very high hardness. Furthermore, the plasma beam, being filtered, ensures a smooth coating devoid of macroparticles, typically less than 300 particles/mm², which means that the cutting resistance of the cutting tool is less than those cutting tools with carbon coatings having relatively high macroparticle density. The inventors have surprisingly found that, in PCB manufacture requiring the boring of a PCB board, the drill bit 10 with carbon coatings substantially free of macro-particles has significantly increased the drill cycle life relative to drill bits coated with known deposition methods.

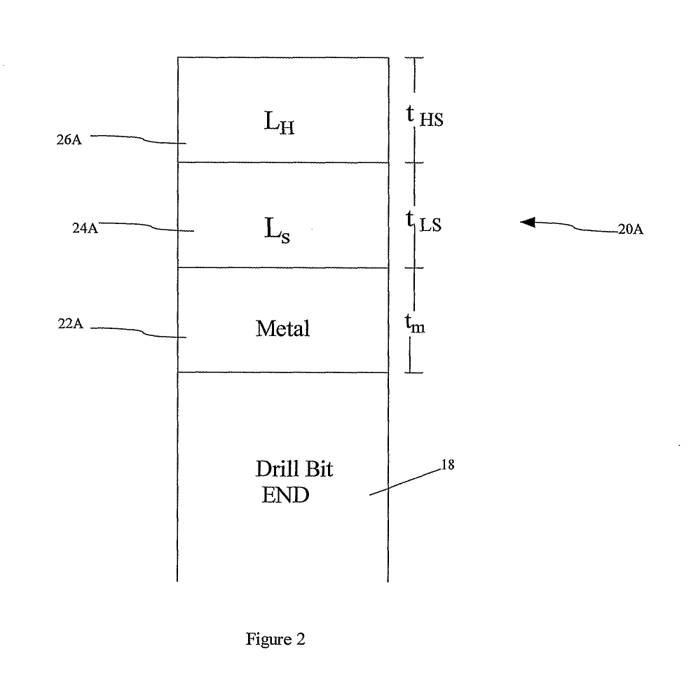

Referring to FIG. 2, there is shown a schematic cross-sectional view of one embodiment of a coating 20A that can be applied to the end 18 of the tool bit 10. The coating 20A consists of a first metal layer 22A that is formed from a filtered plasma beam, generated by the FCVA apparatus, which is deposited onto the end 18 of the tool bit 10. The metal of metal layer 18 is Titanium (Ti) and has a thickness (t_{M}) that is between 0.05 μm to 0.8 μm.

A primary metal carbide layer in the form of titanium carbide (TiC) TiC layer 24A is applied to the metal layer 22A. The primary TiC layer 24A is deposited by the plasma beam during which the tool bit end 18 is biased with a with a bias of −3500V to produce a relatively soft primary TiC layer 24A having a relatively low hardness in the range 15-25 GPa but of reduced stress. The thickness (t_{Ls}) of the primary TiC layer 24A is between 0.05 μm to 0.8 μm.

After the primary TiC layer 24A is formed, a filtered plasma beam of carbon ions continues to be applied to form a carbon layer 26A. Although the initial bias is −3500V it is raised after about 10 seconds to −200V. The lower negative bias increases the hardness of the secondary carbon layer 26A to about 35 GPa. The thickness (t_{Lh}) of the secondary carbon layer 26A is between 0.05 μm to 0.8 μm.

Accordingly, the titanium layer 22A between the tool bit end 18 and the titanium carbide layer 24A, promotes adhesion between the successive layers. Furthermore, the increasing hardness between the titanium carbide layer 24A and the carbon layer 26A results in an increasing hardness in the coating 20A in the direction from the metal layer 22A to the top carbon layer 26A. The increasing hardness ensures that the portion of the carbon coating 20A that is most exposed to a workpiece during a boring operation is the hardest layer, thereby increasing the drill bit 10 cycle life in PCB manufacture.

Furthermore, the successively increasing hard layers from the tool bit end 18 to the top carbon coating layer 26A ensures excellent adhesion so that the coating 20A is held firmly onto the end 18.

Although the layers 24A and 26A are shown in FIG. 2 as two discrete layers, it should be realized that this is for illustrative purposes only. In practice, many layers of increasing hardness from the metal carbide layer 24A to the carbon layer 26A may be formed successively by decreasing the magnitude of the negative bias during deposition of the plasma. Hence, the layers with increasing hardness are not necessarily discretely formed layers as shown in FIG. 2 but may consist of layers of increasing hardness towards the periphery of the coating.

It should also be realized that in some embodiments, a metal carbide layer may be substituted for a pure metal layer. In another embodiment, there is no metal carbide inter-layer or metal inter-layer, the coating is pure carbon.

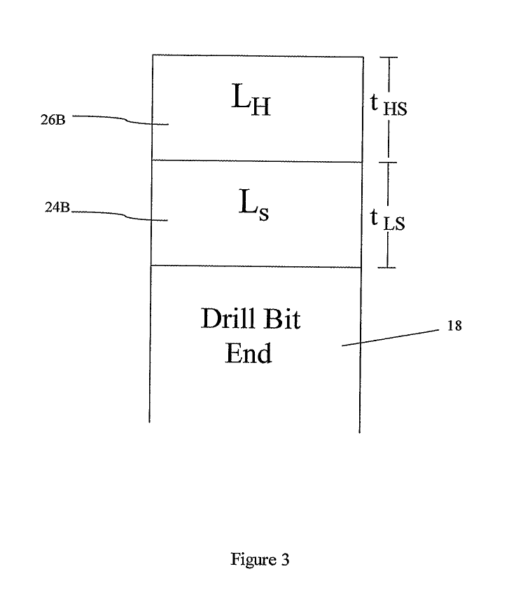

The carbon coating may consist of multiple layers of carbon that are substantially free of macro-particles and which have differing degrees of hardness depending upon the bias that was applied during the plasma deposition process. Referring to FIG. 3, there is shown the same coating as FIG. 2 in which the primary layer 24A of FIG. 2 corresponds to primary layer 24B, the secondary layer 26A of FIG. 2 corresponds to secondary layer 26B and the metal layer 22A is absent.

### Example

WC—Co drill bits with a diameter of 200 μm were coated with carbon coatings using the FCVA apparatus as described above. The carbon coatings consisted of two groups, “Coating A” where the total carbon coating layer was about 0.1 μm and “Coating B” where the total carbon coating layer was about 0.3 μm.

The carbon coatings A and B consisted of a first carbon coating of 0.02 μm for coating A and 0.1 carbon for coating B, during which no bias was applied to the drill bit.

A filtered plasma beam of carbon ions was then applied to the metal layer to form a primary layer of carbon having a thickness of 0.04 μm for coating A and 0.1 for coating B. During formation of the primary layer, pulses of −3600V with a pulse duration of 10 μs and a frequency of 3 kHz was applied to the drill bit for a period of 15 seconds. After formation of the primary carbon layer, a top secondary carbon layer was formed having a thickness of 0.04 μm for coating A and 0.1 for coating B. During formation of the secondary layer, pulses of −150V with a pulse duration of 10 μs and a frequency of 3 kHz was applied to the drill bit for 15 seconds.

The primary carbon layer of both coatings had a hardness of about 15-25 GPa while the secondary carbon layer was about 30-40 GPa.

An advantage of having multiple layers having different hardness is that the outermost layer is much harder while the inner layer, while not as hard, has reduced stress. The combination of these two layers together, in combination with the fact that they are substantially free of macroparticles, provides a cutting surface which is very hard but is subject to less stress and which exhibits reduced cutting resistance when used as a cutting tool.

SEM analysis of the coatings A and B were performed and it was found that the coatings were substantially free of macro-particles. While it was not possible to completely remove the macro-particles from the coatings, the particle density was not more than 300 particless/mm² in both coatings A and B.

A number of drill bit coatings were subjected to Raman spectroscopic analysis wherein the peak intensities of each sample coating were obtained. It was found that the peak intensity (I_{D}/I_{G}) of the sample coatings had relatively hard Raman intensity value of about 0.3 to about 0.5 indicating a relatively hard coating.

The coated drill bits of coatings A and B were then used to drill into a stack of fiberglass board having a total thickness of 5 mm of the type used in PCB manufacture and the number of cycles were recorded before drill bits became dull and needed to be replaced. For comparison, non-coated WC—Co drill bits were also subjected to the same drilling operation and the cycles recorded before these non-coated drill bits needed to be replaced.

A sample set of 2000 drill bits were tested for Coating A, Coating B and non-coated drill bits and the results given in table 1 below.

TABLE 1

| Drill Bit Coating | Average Cycle Life |
|---|---|
| Non-coated drill bits | 1983 |
| (Comparative Example) | |
| Coating A (0.1 μm) | 8961 |
| Coating B (0.3 μm) | 7569 |

Accordingly, it can be seen from the data that the carbon coated drill bits exhibited an almost four-fold increase in the cycle life compared to non-coated WC—Co drill bits. Hence, it will be appreciated that the carbon coatings significantly increase the cycle life of the drill bits in PCB manufacture.

The plasma deposited coatings also exhibited excellent adhesion to the drill bits, thus increasing their cycle life compared to known coating methods.

It is also believed that because the carbon coatings on the drill bits are substantially free of macro-particles, they exhibit lower cutting resistance relative to carbon coatings with higher macro-particle densities which is thought to significantly increase the life cycle of the drill bits. Furthermore, the added combination of the disclosed carbon layers being deposited at different negative biases means that the inner carbon coating has reduced stress while the outer carbon layer has increased hardness relative to each other. This means that the coating is overall of high hardness, reduced stress and exhibits reduced cutting resistance when used as a cutting tool due to the fact that the coatings are substantially free of macroparticles. Hence, the disclosed coatings overcome, or at least ameliorate, some of the disclosed disadvantages of the aforementioned prior art by significantly increasing the life cycle of the cutting tool.

The disclosed carbon coatings therefore overcome the problems associated with high wear rates of such cutting devices such as drill bits.

It will be apparent that various other modifications and adaptations of the invention will be apparent to the person skilled in the art after reading the foregoing disclosure without departing from the spirit and scope of the invention. For example, although the disclosed drill bits, their method of manufacture and their use are particularly useful in PCB manufacture, it will be appreciated that the coatings for the drill bits can be used in other applications such as masonry drill bits. Hence, it is intended that all such modifications and adaptations come within the scope of the appended claims.

1. A cutting tool comprising:
a body;
a cutting edge on at least one part of said body; and
a plasma deposited carbon coating layer provided on said cutting edge that is substantially free of macro-particles.

2. A cutting tool as claimed in claim 1, wherein said body comprises: a cylindrical body having a longitudinal axis.

3. A cutting tool as claimed in claim 2, comprising a tool engagement end on one end of said cylindrical body, opposite to said cutting edge, for engagement with a tool capable of rotating said cylindrical body about said longitudinal axis.

4. A cutting tool as claimed in claim 1, wherein said carbon coating layer has a thickness selected from the group consisting of 20 nm to 5000 nm, 250 nm to 5000 nm, 250 nm to 3000 nm, 250 nm to 2000 nm, 250 nm to 1500 nm, 250 nm to 1000 nm, 500 nm to 3000 nm, 500 nm to 2500 nm, and 1000 nm to 2000 nm.

5. A cutting tool as claimed in claim 1, wherein said hard coating layer has a hardness of at least 10 GPa.

6. A cutting tool as claimed in claim 5, wherein said carbon coating layer has a hardness of 10 GPa to 60 GPa or 20 GPa to 45 GPa.

7. A cutting tool as claimed in claim 1, wherein said carbon coating layer coating layer comprises a primary layer provided on said working end and a secondary layer provided on said primary layer, wherein the hardness of said secondary layer is higher than said primary layer.

8. A cutting tool as claimed in claim 7, wherein said primary layer has a hardness of 5 GPa to 10 GPa and said secondary layer has a hardness of 10 GPa to 35 GPa.

9. A cutting tool as claimed in claim 7, wherein said primary and secondary layers independently have respective thicknesses within the range of 10 nm to 2500 nm, 250 nm to 2000 nm, 500 nm to 1000 nm, and 800 nm to 1500 nm.

10. A cutting tool as claimed in claim 1, comprising a metal carbide or metal inter-layer between said cutting edge and said carbon coating layer.

11. A cutting tool as claimed in claim 10, wherein said metal carbide or metal layer includes transition metals selected from the group consisting of Ti, Zr, Hf, V, Nb, Ta, Cr, Mo, W, Fe, Ru, Os, and combinations thereof.

12. A cutting tool as claimed in claim 10, wherein said metal carbide inter-layer is at least one of titanium carbide and chromium carbide and said metal inter-layer is at least one of titanium and chromium.

13. A cutting tool as claimed in claim 1, wherein said carbon coating layer has been deposited using a filtered plasma of carbon ions.

14. A cutting tool as claimed in claim 13, wherein said filtered plasma of carbon ions have been generated from a cathodic vacuum arc.

15. A cutting tool as claimed in claim 1, wherein said cutting tool is a printed circuit board (PCB) drill bit.

16. A cutting tool as claimed in claim 1, wherein said cutting tool is a printed circuit board (PCB) router bit.

17. A cutting tool as claimed in claim 2, wherein said cylindrical body has a diameter selected from the group consisting of 0.001 mm to 3 mm; 0.01 mm to 3 mm; 0.05 mm to 3 mm; 0.05 mm to 2 mm; 0.05 mm to 1 mm; 0.05 mm to 0.5 mm and 0.05 mm to 0.25 mm.

18. A cutting tool as claimed in claim 1, wherein the body comprises tungsten carbide and cobalt.

19. A cutting tool as claimed in claim 1, characterized in that the carbon coating layer exhibits Raman intensity values of between about 0.3 to about 1.

20. A cutting tool as claimed in claim 1, wherein multiple layers of said carbon coatings have been deposited on said cutting edge having generally increasing hardness in a direction from said cutting edge to the periphery of said carbon coating layer.

21-35. (canceled)
